(19) United States
(12) Patent Application Publication
(10) Pub. No.: US 2012/0308064 A1
(43) Pub. Date: Dec. 6, 2012

(54) Mobile Device Protective Case with Built-in Speaker System

(76) Inventor: Demitrius Matthews, Excelsior, MN (US)

(21) Appl. No.: 13/477,228

(22) Filed: May 22, 2012

Related U.S. Application Data
(60) Provisional application No. 61/493,182, filed on Jun. 3, 2011.

(51) Int. Cl. H04R 1/02

(52) U.S. Cl. 381/334

(57) ABSTRACT

A mobile device protective case is provided that facilitates the playback of audio via an imbedded speaker system. The protective case comprises a front portion, a rear portion hingedly secured thereto, an TRS connector auxiliary (AUX) audio jack, a signal processing means, at least one speaker and a power source. The speakers, signal processing means and power source are housed within the rear portion of the case. The AUX jack is electrically connected to the signal processing means such that when connected to a mobile device, audio signals may be sent to the signal processing means and to the speakers. The speakers may be used when the protective case is open or closed. This gives a user the option of enclosing the device in the case to protect the same, or leaving the case open to provide access to the user interface of the device.

### CROSS REFERENCE TO RELATED APPLICATION

This application claims the benefit of U.S. Provisional Application No. 61/493,182, filed on Jun. 3, 2011 entitled “Sound Case.”

### BACKGROUND OF THE INVENTION

1. Field of the Invention

The present invention relates to a mobile device protective case. More specifically, it relates to a protective case that provides audio playback via an embedded signal processing and speaker system.

Mobile devices such as cellphones, personal digital assistants (PDAs) and tablet computers are often used to store audio and video files. To reduce the clutter in their lives many people use one device to store their media files, rather than having multiple devices that perform overlapping functions. Media files are communicated to a user by means of headphones and a screen, on which a video file or user interface is displayed. In certain instances, such as when a user is not in transit, is in a solitary environment, or alternatively when multiple users wish to hear the playback, it may be desirable to employ speakers rather than headphones. The use of speakers provides a user with the ability to listen to music while at work, school or the like, while still maintaining the ability to hear environmental sounds and noises. However, a downside to portable speakers is that they are often bulky and cumbersome, and require a power source such as a computer USB port or a wall electrical outlet.

It is also common for users to place mobile devices in carrying cases to protect delicate components such as screens and microphones. These cases are particularly advantageous when a mobile device is in being transported or is placed in an environment where the device may counter liquid or debris. Users may choose to leave their mobile device in a protective case while the device rests on a workplace desk to prevent beverages or objects from falling on the device. A mobile device case that provides a user with means for protecting a mobile device, while allowing the same case to project audio playback is contemplated by the present invention to fill a void in the prior art.

2. Description of the Prior Art

The prior art contains a variety of mobile device protective cases for providing protection to an electronic media storage device while allowing use thereof. These prior art cases have familiar design and structural elements for the purposes of providing access to the features of a phone while enclosed in a case; however they are not adapted for the task of housing a means of projecting audio playback while providing physical protection for the mobile device therein.

Wood et al, U.S. Pat. No. 7,400,917 discloses a case for a portable communication device comprising a housing having a closed and open position, an input component, an output component and a signal processing means. The input component may be a microphone and or a keypad, adapted to allow a user to give instructions to the device encapsulated within the housing. The signal processing means translates verbal directives given into command signals that are interpretable by the electronic device. This signal processing means also translates signals from the mobile device into audio output. Audio or visual output is played back to a user by the output means that comprises a speaker, and or a video screen. Users may operate their cellphone in a hands-free mode while it is housed within the case. This prevents water and dust from accumulating on the phone. The case of Wood has a battery that powers the case, unlike the present invention, which draws power from the electronic device. Wood also does not disclose the uninterrupted playback of music through the speakers, rather, Wood relates to a case having speakers that can produce audio feedback from phone calls and responses to user input.

Hetterick, U.S. Pat. No. 6,456,487 discloses a protective enclosure for an electronic device. The device comprises a housing having a front portion and a back portion, a first grip, a second grip, a notification indicator, and an actuator. The front portion is secured to the back portion to create a housing for a cell phone. The first and second grips are high-tactile rubber portions disposed on the sides of the protective enclosure. When the phone receives a call, the indicator activates to notify a user. This indicator may be an led light, an LCD display or other visual indicating means. The actuator may be a flexible membrane that permits a user to depresses keys on a cellphone keypad, while the cellphone is enclosed within the protective case. An output means comprising speakers, is disposed on the protective case and electrically connected to the mobile device. Hetterick is adapted for the sole use of housing a cell phone. Further, Hetterick does not disclose a case that permits the playback of audio while the case is in either an open or a closed position.

The devices disclosed by the prior art do not address the need for accommodating a variety of mobile devices or permitting the playback of audio while the case is in either a closed or open position. The current invention relates to a case for playing music stored on a mobile device or streamed therefrom, while the device is retained within the case. It substantially diverges in elements from the prior art; consequently it is clear that there is a need in the art for an improvement to the existing mobile device protective cases. In this regard the instant invention substantially fulfills these needs.

### SUMMARY OF THE INVENTION

In view of the foregoing disadvantages inherent in the known types of mobile device protective cases now present in the prior art, the present invention provides flexibility by providing audio playback means usable with a variety of mobile devices, wherein the same can be utilized for providing convenience for the user when playing music stored on or streamed from the mobile device, while the same is encapsulated within the protective case.

The present protective case comprises a housing, an audio output means, a connecter jack and a signal processing means. The housing has a front portion and a back portion that are hingedly connected. When the front and back portions are folded together they define an interior space suitable for retaining a mobile device such as a cellphone, an MP3 player, a tablet computer or a PDA. A removable securement means such as a zipper or a slide lock may extend along at least a portion of the side edge opposing the hinging means. An aperture is disposed along an edge of the case corresponding to the position of an audio auxiliary (AUX) port on the mobile device. Near this aperture, an auxiliary (AUX) jack having a TRS connector extends upward from within the rear portion of the case. The AUX jack may be plugged into the AUX port on the mobile device and through the aperture in the case to affect an electrical connection between the mobile device and the signal processing means.

A signal processing means translates the electrical signal transmitted by the mobile device, into audio signal that is sent to the speakers. At least one speaker is housed within the rear portion of the device for the purposes of providing audio output of music files stored on the mobile device. The speaker receives signals from the signal processing means and relays sound accordingly. The speaker system encapsulated within the rear of the case may be powered by a battery source housed therein. Alternatively the speaker system may draw power from the device itself via a USB connection or similar electrical connection. In either embodiment, a power switch is disposed along the top edge of the device to reduce the drain of power when the device is not in use as a music player. In an alternative embodiment, the speaker systems may be housed within the front portion of the case.

To prevent users from inadvertently interrupting the continuous playback of music, the protective case forms a solid housing with no portions that provide access to the user interface of the mobile device. This prevents accidental selection of options on the mobile device's user interface and reduces the risk that a user will inadvertently change the song or interrupt the music. If access to the user interface is desired the protective case may be opened and used as a stand. In this manner the user may have access to the mobile device while music is playing from the speakers. In an alternate embodiment volume controls are disposed along the top edge of the protective case. In another alternative embodiment, clamps may be disposed along upper and/or lower interior edges of the front portion of the case. These clamps retain the mobile device while it is in the case to prevent the device from shifting if the protective case is in an open position.

It is therefore an object of the present invention to provide a new and improved mobile device protective case having all of the advantages of the prior art and none of the disadvantages.

Another object of the present invention is to provide a new and improved mobile device protective case having at least one speaker housed within the case to provide audio playback of music stored on or streamed from the mobile device.

Yet another object of the present invention is to provide a new and improved mobile device protective case having solid construction to prevent accidental interaction by a user with the user interface of the mobile device.

Still another object of the present invention is to provide a new and improved mobile device protective case that is powered by a battery source.

A further object of the present invention is to provide a new and improved mobile device protective case that includes a speaker system that is powered by the mobile device.

A still further object of the present invention is to provide a new and improved mobile device protective case providing music playback capabilities when the protective case is in either an open or closed position.

Another object of the present invention is to provide a new and improved mobile device carrying case having durable and resilient construction.

Other objects, features and advantages of the present invention will become apparent from the following detailed description taken in conjunction with the accompanying drawings.

### BRIEF DESCRIPTIONS OF THE DRAWINGS

The above invention will be better understood and the objects set forth above as well as other objects not stated above will become more apparent after a study of the following detailed description thereof. Such description makes use of the annexed drawings wherein like numeral references are utilized throughout.

FIG. 1 shows a perspective view of the present mobile device protective case in an open position with a tablet computer restrained therein.

FIG. 2 shows a perspective view of the present mobile device protective case in a closed position.

FIG. 3 shows a block diagram of the speaker system of the present mobile device protective case

### DETAILED DESCRIPTION OF THE INVENTION

Reference is made herein to the attached drawings. Like reference numerals are used throughout the drawings to depict like or similar elements of the mobile device protective case. For the purposes of presenting a brief and clear description of the present invention, the preferred embodiment will be discussed as used for providing audio playback of files stored on the mobile device. This is for representative purposes only and should not be considered to be limiting in any respect.

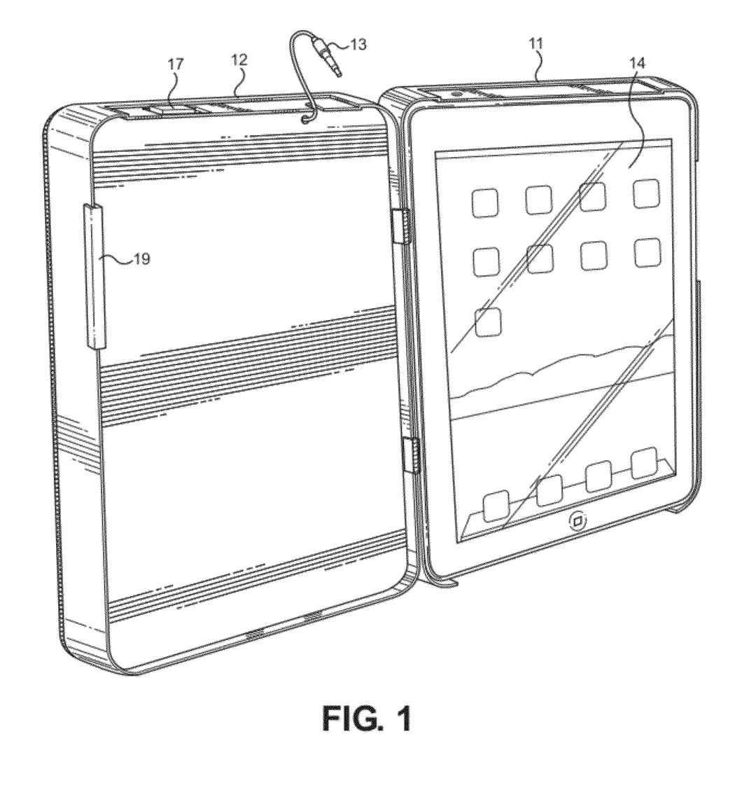

Referring now to FIG. 1, there is shown a perspective view of the mobile device protective case of the present invention having a tablet computer 14 retained therein. The protective case comprises a front portion 12, a rear portion 11, an AUX jack 13 and a speaker system imbedded within the case. The front 12 and rear 11 portions are hingedly connected along a side edge such that the portions may fold together to define an interior space. The interior space is adapted to retain a mobile device. Devices such as cellphones, PDAs, tablet computers and the like may be placed within the disclosed protective case, depending on size and geometry of the case and the housed device. When the case is placed in an open position, the user has full access to the user interface of the device, as illustrated in FIG. 1.

When the protective case is placed in the open state, it provides the functionality as a physical support stand for the mobile device retained inside. In this support stand position, the protective case provides a user with access to the user interface of the mobile device, allowing the user to change song tracks or select other options on the mobile device. The hinged securement of the front portion 12 to the rear portion 11 enables a user to adjust the position of the speakers by rotating that portion inward to or outward from the closed position. In the support stand position, a user may operate the device as in normal operation, manually selecting playback or interfacing with the device as desired. The closed position is ideal for users who wish to activate a continuous “playlist” or stream of music, leaving the device to operate independently of user control while music or other audio is played. The protective case may come in a variety of sizes and shapes to accommodate a wide range of mobile devices. It may also be made from any durable material suitable for construction of a protective case offering shock or impact resistance, such as plastic, rubber or the like.

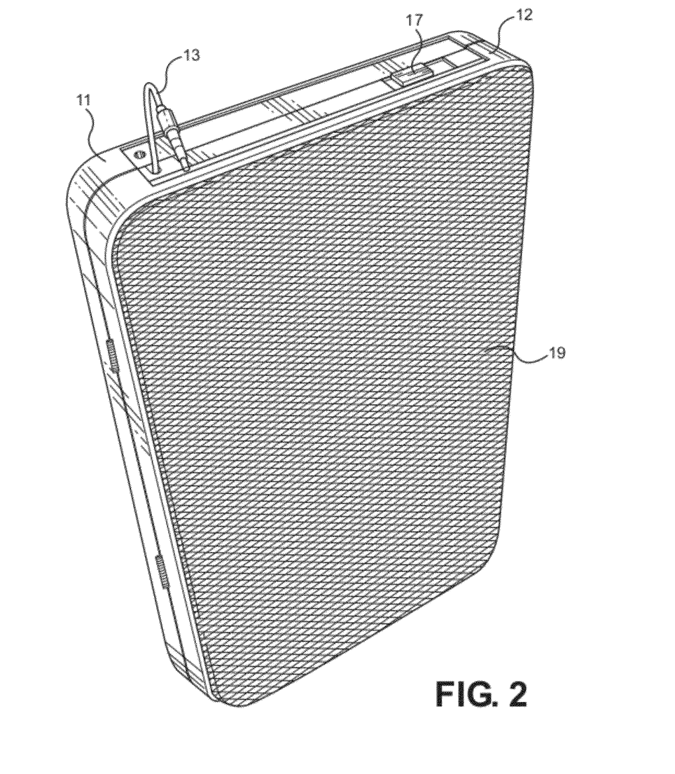

Referring now to FIG. 2, there is shown a perspective view of the protective case in a closed position. When the front 12 and rear portions 11 of the case are folded together and secured, the mobile device is protected from liquids and particulate debris in the surrounding environment. The portions may be removably secured by a securing means 19 (see FIG. 1) disposed along at least a portion of the side opposing the hinged connection. Securing means such as sliding locks, zippers, snaps or other fasteners may be used. Along the top of the protective case there is disposed a power switch 17 for turning the speaker system on and off. This prevents drain on a power source while the speaker system is not in use.

Along a corner of the device upper, the AUX jack dongle 13 extends upwardly from within the front portion. The AUX jack 13 has a working end comprising a TRS connector disposed at the working end of the dongle for connection with the audio output of the mobile device. An aperture extends through the top edge of the protective case and is adapted to permit the working end of the AUX jack to be inserted therethrough. The aperture is disposed in correspondence to the position of an AUX port on the mobile device housed within the case. In this manner the AUX jack may be inserted through the aperture and connected to the AUX port of the mobile device. Its position along the exterior of the case allows the mobile device to be operably connected thereto, or alternatively unplugged therefrom without subsequent removal of the device from the case. In this way, the dongle 13 may be removed from the mobile device while the device is still housed within the case, providing continued protection of the device while disengaging the speaker. The user may also connect a third party dongle to the mobile device if desired, allowing a hands free headset or headphones to be attached to the device while still housed within the case.

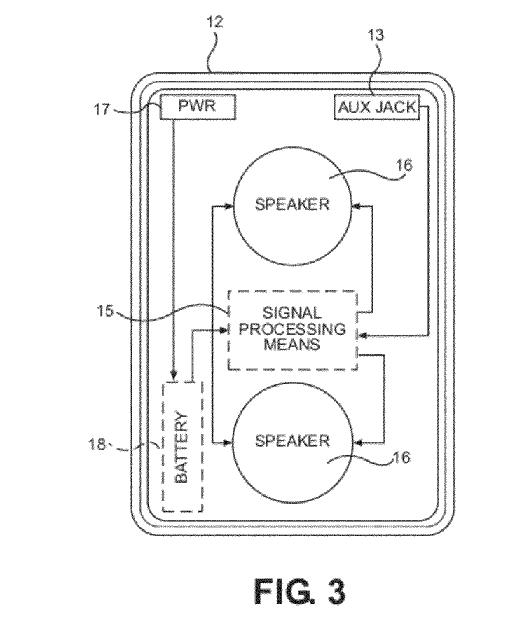

In an alternative embodiment of the dongle configuration, the AUX jack dongle extends downward from within the case (see FIG. 3). The jack may be inserted into the AUX port of a device without protruding outside of the speaker case. The AUX port provides an electrical connection between the mobile device and the speaker system so as to facilitate the transmission of music files thereto.

Disposed along the forward surface 19 of the front portion 12 of the case is a speaker cover, which allows transmission of audio from the internally housed speaker with minimal interference, while providing protection against foreign object debris such as a dirt, sand and other particulate matter. The construction of the speaker grill is preferably a hard material, such that the internal components are provided a level of shock and impact protection, which is of particular concern for a mobile device being consistently handled and transported. A soft grill cover may also be utilized if desired, provided a lower weight case for a tradeoff of protection for the speaker components.

Referring now to FIG. 3, there is shown a block diagram of the speaker system components. The components are encapsulated within the front portion 12 of the protective case. It is also contemplated that the speaker system components may be housed within either portion of the case, depending on physical limitations of the case/mobile device and manufacturing concerns. In either embodiment, the speaker covering extends across the entirety of the outer surface of the pertinent portion of the protective case. The interior surface of the relevant portion of the protective case has the same interior construction as the interior surface of the opposing portion. Thus the speaker system is housed between the speaker covering surface and the interior case surface. Consequently, the portion housing the speaker system may be thicker than the opposing portion of the case.

When the AUX jack 13 is plugged into an AUX port on the mobile device, the jack forms an electrical connection between the mobile device and the signal processing means 15. The signal processing means interprets the electrical signals and translates them into electrical signals that the speaker(s) 16 converts into vibrations and physical speaker movement, resulting in audio output. This system allows music from the mobile device to be played through the speaker system of the protective case. A power source comprising a battery 18 is operatively connected to the speakers to provide power to the same when the protective case is in use as a music player. To save power, a switch 17 is operatively connected to the battery source to turn the battery source on when music is desired and off after audio output is finished.

In one embodiment, securing means are disposed within the interior portion not having the disclosed speaker system. The securing means is adapted to retain the mobile device within the recess of the interior, while the protective case is used in an open position. Securing means such as clamps, elastic bands, or straps with hook and loop fasteners may be employed. In another embodiment, the interior of the protective case may feature a USB jack or a docking jacking adapted to operatively connect with a corresponding port on a mobile device and permit the transfer of power from the device to the speaker system. This embodiment provides a power source in the form of the mobile device itself instead of using an independent battery source.

In use an individual places a mobile device such as a cellphone, PDA, tablet computer or the like into the interior recess of the back portion of the protective case. The AUX jack is plugged into the AUX port of the mobile device through an aperture in the protective case. The mobile device is then switched on and an audio program is selected. A user then turns on the speaker system of the protective case by moving the power switch into an “on” position. An activation button or “play” icon on the mobile device user interface is then pushed. Audio playback should begin to emanate from the speakers. The user can choose to close the protective case, thereby encapsulating and protecting the mobile device. This prevents accidental jarring of the mobile device that could result in interrupt to the playback of music. Alternatively the device may be rested on its bottom edge in an open, support stand position. This position provides a user with access to the user interface of the mobile device so that he or she may change audio tracks as desired.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim the following:

1) A protective case for a mobile device, comprising:
a front portion hingedly secured along a first side to a rear portion, wherein said front and rear portions define an interior having a front and rear interior surface, said interior adapted to house said mobile device;
said front and rear portions being removably secured by a securing means disposed along sides of the case opposing said hinged securement;
at least one speaker;
a signal processing means;
an AUX jack operatively connected to said signal-processing means, adapted to connect to an audio output port of said mobile device;
a power source providing power to said signal processing means and said at least one speaker, operatively connected to a power switch;
said at least one speaker, signal processing means and said power source being housed within said front portion between a speaker cover and said front interior surface.

2) The device of claim 1, wherein volume control buttons are disposed along a top surface of said portion housing said speakers.

3) The device of claim 1, wherein said securement means comprises a zipper.

4) The device of claim 1, wherein said securement means comprises a sliding lock

5) The device of claim 1, wherein said power source is a battery.

7) The device of claim 1, said power source is said mobile device power source.

8) The device of claim 7, wherein said mobile device powers the electrical components of the protective case by means of a USB jack.

9) The device of claim 7, wherein said mobile device powers the electrical components of the protective case by means of a docking jack.

10) The device of claim 1, wherein said front portion further comprises an aperture through which said AUX jack extends through to operably connect to said mobile device audio output port, said port being accessible through an aperture in said rear portion to connect thereto without requiring said case to be opened.

11) The device of claim 1, wherein said AUX jack is secured within said rear portion and operably connects to said mobile device audio output port while said case is in an open position only.
